(19) United States
(12) Patent Application Publication
(10) Pub. No.: US 2010/0140900 A1
(43) Pub. Date: Jun. 10, 2010

(54) Hitch Guide Device

(76) Inventor: Scott Zinn, Mishicot, WI (US)

Correspondence Address: BOYLE FREDRICKSON S.C., 840 North Plankinton Avenue, MILWAUKEE, WI, 53203, US

(21) Appl. No.: 12/329,660

(22) Filed: Dec. 8, 2008

(51) Int. Cl. B60D 1/36; B60D 1/06

(52) U.S. Cl. 280/477; 280/511

(57) ABSTRACT

A hitch device assembly having a lift and alignment guide that is moveably positioned relative to a ball. The guide is moveably connected to a hitch having a ball connected thereto. The guide includes a top wall having an opening and a pair of side wall that extend downward from the top wall. The opening cooperates with the ball such that the guide is movable between an up position wherein the ball is not exposed, and a down position wherein the ball is exposed for engagement with a towable device. A number of cams extend from the hitch and cooperate with respective channels formed in the side walls of the guide. The ball opening and the respective channels and cams are positioned such that the guide cooperates with the tongue of a towable device in a manner that guides the tongue forward and downward into position over the ball.

### BACKGROUND OF THE INVENTION

The present invention relates generally to hitches for connecting towed vehicles, such as trailers or the like, to towing vehicles, such as automobiles or other engine powered equipment or machines. More particularly, the present invention relates to a guide assembly having a movable guide that cooperates with a hitch drop and interacts with the tongue of a towed vehicle to guide the tongue into engagement with a ball of the towing vehicle.

The difficulty associated with aligning a hitch secured to a towing vehicle to a towable vehicle is well known. Unskilled operators, or drivers who have not secured such mating structures in some time, often require several attempts to adequately align the hitch of the vehicle to the tongue of a vehicle to be towed. Although adequately aligned, the tongue and/or hitch still require some degree of manual physical manipulation to align the tongue and the ball for engagement with one another. Even skilled drivers/operators have to frequently physically manipulate the position of the tongue of a trailer or other towable device so as to properly engage a ball of a hitch with the tongue of the trailer.

Others have recognized similar difficulties and have presented various solutions intended to simplify connecting towed and towing vehicles. Such systems are not without their respective drawbacks. Some such systems, such as that disclosed in U.S. Pat. No. 6,102,422 provide relatively simple assemblies that facilitate physical aligmnent of a tongue with a ball via a retractable yoke assembly that cooperates with one or the other of the tongue and the hitch. Although such systems are simple to operate and integrate into existing devices, such systems only provide lateral alignment of the tongue relative to the ball and do not assist with height alignment of the tongue for subsequent engagement with the ball.

Still other systems, such as that disclosed in U.S. Pat. No. 5,769,443, involve generally convoluted bracket assemblies that generally surround the tongue and hitch engagement. Proper use of such systems generally requires user attention to multiple movable and adjustable components of the hitch assembly to ensure the proper operation thereof. Still other systems, such as that disclosed in U.S. Patent Application Publication 2005/0230935, disclose hitch systems wherein the ball is movably supported such that the ball can be rotated into and out of engagement with a ball joint associated with a towable vehicle. Such systems translate the load that must be supported by the ball to the moveable joints between the ball the hitch.

Still other systems require accessories that are individualized for use with the respective guidance system. One such system is disclosed in U.S. Patent Application Publication No. 2007/0057485 which discloses a trailer hitch guidance systems that includes a gender changing hitch connection or dual ended ball arrangement and a hitch configured to receive a ball rather to engage a ball joint. The system disclosed in U.S. Patent Application Publication No. 2007/0057485 also includes an attachment that extends rearward from the ball of the hitch and functions as a skid pan as the gender altering ball assembly that is secured to the towable vehicle passes thereacross. Such a system provides a generally obtrusive hitch guide and securing system when attached to a vehicle as compared to a conventional ball supporting hitch.

Therefore, there is a need for a hitch guide device that guides and aligns the tongue or ball hitch of a towable vehicle into alignment with a ball secured to a towing vehicle. There is a further need that such a system be generally unobtrusive and that the load associated with the towable vehicle be communicated near as possible directly to the frame or other fixed structure of the towing vehicle. It would also be desirable to have a hitch guide assembly that can accommodate a number of towable vehicle securing devices without unduly interfering with securing a towable vehicle to a towing vehicle. It is further desired to provide a hitch guide assembly that is simple to operate and assists in raising and lowering the tongue of a towable vehicle with respect to a ball secured to a towing vehicle.

### BRIEF DESCRIPTION OF THE INVENTION

The present invention provides a hitch guide assembly and method of selectively exposing a ball for engagement with a trailer that overcomes one or more of the aforementioned drawbacks. A hitch guide assembly according to one aspect of the invention includes a lift and alignment guide that is moveably positioned relative to a ball. The guide is moveably connected to a hitch drop having a ball connected thereto. The guide includes a top wall with an opening and a pair of side walls that extend downward from the top wall. The opening cooperates with the ball such that the guide is movable between an up position wherein the ball is not exposed, and a down position wherein the ball is exposed for engagement with a towable device. A number of cams extend from an adapter that is attached to the hitch drop and cooperate with respective channels formed in the side walls of the guide. The ball opening and the respective channels and cams are positioned such that the guide cooperates with the tongue of a towable device in a manner that guides the tongue forward and downward into position over the ball so as to reduce user effort in connecting towable devices to tow vehicles. Such a hitch guide system for connecting towed vehicles to towing vehicles is robust, simple to operate, and easily integrated with common hitch or hitch drop assemblies.

Another aspect of the invention usable with one or more of the features or aspects above discloses a hitch guide assembly for assisting in connecting towable devices to a tow vehicle. The hitch guide assembly includes a body that is securable to the tow vehicle in a fixed position. A post or ball extends from the body for engaging a tongue of the towable device. A guide is movably secured to the body so as to be movable with respect to the post. A first cam and a second cam are positioned on generally opposite lateral sides of the body. Each of the first and second cams cooperates with a forward channel formed in a respective side of the guide. A third cam and a fourth cam are positioned rearward of the first and second cams and positioned on the opposite lateral sides of the body. Each of the third and fourth cams cooperates with a rearward channel formed in the respective sides of the guide. Such a hitch assembly is repeatably operable.

A further aspect of the invention that is combinable with one or more of the aspects or features above discloses a hitch assembly having a tube for being received in a receiver that is commonly secured to a tow vehicle. The assembly includes a ball for engaging the tube and for cooperating with a tongue of a towable device and an adapter for being secured to the tube. A forward cam shaft and a rearward cam shaft are secured to the adapter. A cam is secured to each generally lateral opposite end of each cam shaft. The assembly includes a guide that has a top wall and a pair of opposite lateral side walls. An opening is formed in the top wall and shaped to allow the ball to pass uninterrupted therethrough. A forward cam path and a rearward cam path are formed in each side wall. Each cam path cooperates with a respective cam to define motion of the guide relative to the ball. A biasing device biases the guide to a position wherein the opening is generally above the ball.

Yet another aspect of the invention usable with one or more of the aspects and features discussed above includes a method of selectively exposing a ball for engaging a trailer. The method includes mounting an adapter to a hitch having a ball secured thereto. A guide is secured to the adapter with a number of cam interfaces such that the guide is movable between a raised position wherein a top wall of the guide is positioned over the ball and a lowered position wherein the top wall is positioned generally below the ball. The method includes biasing the guide toward the raised position so as to assist in raising and lowering the tongue of a towable vehicle.

In a preferred aspect, the hitch guide assembly includes four cams and four cam paths that are divided among the opposite lateral or outboard sides of the hitch guide assembly. Preferably, each of the cams and cam paths are oriented as front and back and left and right, cam interfaces. Preferably, each rearward cam path is generally V-shaped whereas the forward cam paths are nearer L-shaped. More preferably, each forward cam path includes first and second portions that are oriented at an obtuse angle with respect to each other. Preferably, each rearward cam path includes first and second portion that are oriented at an acute angle with respect to each other.

Preferably, a cover or plate is positioned outboard of the cams and cam paths and prevents dirt, debris, or obstructions from hindering desired movement of the guide.

These and various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is right rear perspective view of a hitch assembly according to the present invention;

FIG. 2 is an above rear perspective view of the hitch assembly shown in FIG. 1;

FIG. 3 is left exploded view of the hitch assembly shown in FIG. 1;

FIG. 4 is a cross-sectional elevation view of the hitch assembly taken along line 4-4 shown in FIG. 2 and shows a tongue of a towable device being introduced thereto;

FIG. 5 is a view similar to FIG. 4 and shows rotation of the guide relative to the ball of the hitch assembly as the tongue of the towable device moves forward over the guide;

FIG. 6 is a side elevation view of the hitch assembly shown in FIG. 1 with the towable device engaged with the ball attached to the hitch; and

FIG. 7 is a cross-sectional elevation view of a cam arrangement of the hitch assembly taken along line 7-7 shown in FIG. 6.

### DETAILED DESCRIPTION OF THE PREFERRED EMBODIMENT

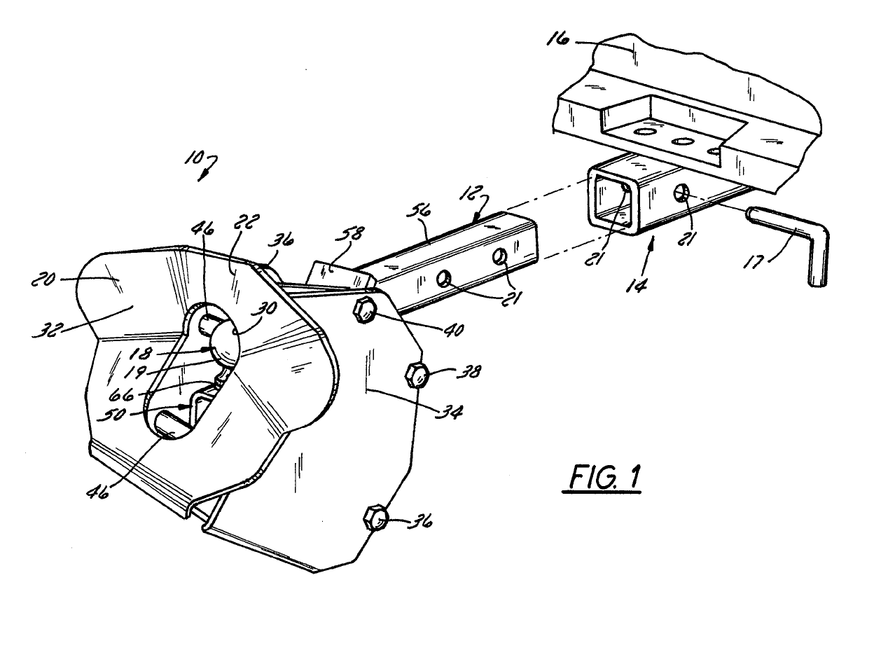

FIG. 1 shows a hitch guide assembly or guide assembly 10 according to the present invention. Guide assembly 10 is secured to a tube or drop 12 that slidably engages a receiver 14 secured to a vehicle 16, such as an automobile or the like. Guide assembly 10 is secured to drop 12 by a post or ball assembly 18 that is secured to drop 12. Those of ordinary skill in the art will readily appreciate the common reference to drop 12 and ball assembly 18 as a “hitch” that is commonly configured for cooperation with a respective towing vehicle 16. Those of ordinary skill in the art will also appreciate that drop 12 is commonly provided in a variety of shapes and configurations. Commonly, as described further below, drop 12 is defined at least in part by the offset between a flat portion of the drop with respect to a tube portion of the drop. A hitch pin 17 cooperates with a number of openings 21 formed in each of receiver 14 and drop 12 so as to selectively secure the combined hitch and guide assemblies to vehicle 16. It is appreciated that, depending on the orientation drop 12 is inserted into receiver 14, drop 12 may actually increase the elevation of ball assembly 18 relative to receiver 14. Those skilled in the art will readily appreciate the existence as well as the utility of such variations as environmental conditions dictate.

Guide assembly 10 includes a guide 20 that is movable relative to drop 12 and ball 19. Guide 20 includes a top plate 22 and a pair of side walls 24, 26 that extend down and away from top plate 22. An opening 30 is formed in top plate 22 and is generally aligned with ball 19. Top plate 22 includes an upper surface 32 that is generally cup shaped or otherwise tapered toward opening 30. A cover 34 is secured to each opposite lateral side of guide assembly 10 by one or more fasteners 36, 38, 40. Each cover 34 is secured to a respective sidewall 24, 26 of guide 20 of guide assembly 10 such that, as described further below, covers 34 move with guide 20.

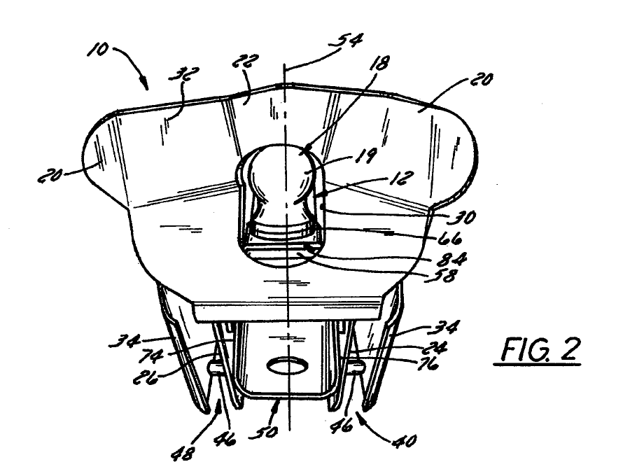

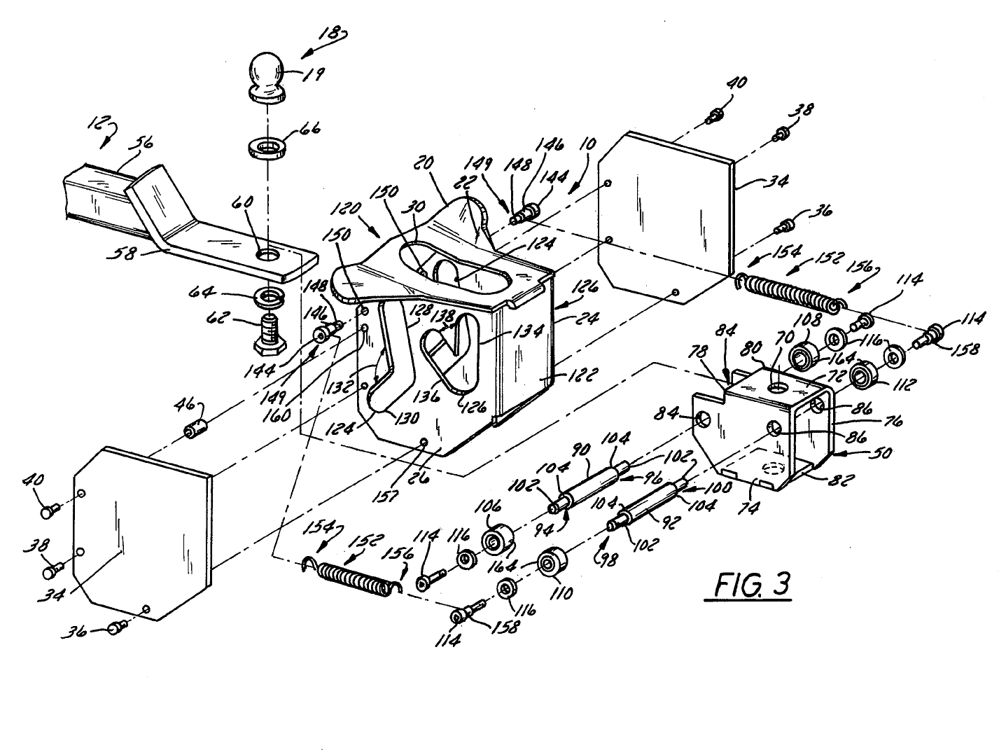

As shown in FIG. 2, an optional spacer 46 is associated with each fastener 36, 38, 40 (FIG. 1) and provides a space or an offset 48 between each cover 34 and respective sidewall 24, 26 of guide 20. Guide assembly 10 includes a body or adapter 50 that is fixedly secured to drop 12. As described further below with respect to the FIGS. 3-7, side walls 24, 26 of guide 20 cooperate with adapter 50 so as to allow translation of top plate 22 relative to ball 19.

Preferably, each of guide 20, covers 34, and adapter 50 are formed of metal material. More preferable, each of guide 20, covers 34, adapter 50 is formed of ¼ inch steel plate although other thicknesses and materials (such as aluminum and/or stainless steel materials may be used to improve the wear and/or appearance characteristics of any of such article. It is further envisioned that guide 20, covers 34, and/or adapter 50, be powered coated or otherwise treated to provide a desired appearance and/or corrosion resistance. For clarity, a front plate has been removed from between the rearward facing ends of sidewalls 24, 26 of guide 20 to expose the generally flanking orientation of sidewalls 24, 26 relative to adapter 50. As best shown in FIG. 2, opening 30 of guide 20 is generally laterally aligned with respect to a longitudinal center plane 54 of guide assembly 10 and ball 19 such that ball 19 can pass uninterruptedly through opening 30 formed in top plate 22 of guide 20.

FIG. 3 shows an exploded view of guide assembly 10 with drop 12 and ball assemblyl 8 also exploded from guide assembly 10. As is commonly understood, drop 12 generally includes a tube section 56 that is configured to cooperate with a receiver securable to a towing vehicle and a flat section 58 that commonly has an opening or hole 60 formed therethrough. Drop 12 is commonly provided in a number of configurations that are differentiated by an offset distance of flat section 58 relative to a longitudinal center axis 59 of tube section 56. As mentioned above, those skilled in the art will readily appreciate that tube section 56 could be rotated 180 degrees and inserted into receiver 14 thereby inverting drop 12 to raise or provide a rise to ball assembly 18. Ball assembly 18 includes a fastener 62 that cooperates with a washer 64 and a lift ring 66 and engages a threaded opening 68 formed in an underside of a hitch ball or ball 19. Alternatively, a threaded post could extend from ball 19 and cooperate with a nut after passing through hole 60 of flat section 58 so as to secure ball 19 to drop 12.

Still referring to FIG. 3, an opening 70 is formed in a top wall 72 of adapter 50. Opening 70 is constructed to generally cooperate with fastener 62 of ball assembly 18 such that opening 70 is positioned in coaxial alignment with hole 60 of flat section 58 of drop 12 and secured thereto by ball assembly 18. Adapter 50 includes opposite facing side walls 74, 76 that extend downward from generally opposite lateral edges 78, 80 of top wall 72. Adapter 50 includes a bottom wall 82 that extends between side walls 74, 76 and is offset from top wall 74. It is appreciated that walls 72, 74, 76, 82 could be formed of a unitary body being bent into the desired shape and/or a number of individual elements secured together, such as by welding, to provide the generally tubular construction of adapter 50. It is further appreciated that adapter 50 could be provided as an integral part of drop 12 or be otherwise non-removable therefrom, such as by being welded to flat section 58 of drop 12. Understandably, such a configuration would detract from the user's ability to interchangeably connect guide assembly 10 to differently shaped drops.

A first or forward opening 84 and a second or rearward opening 86 are formed in each side wall 74, 76 of adapter 50. Each opening 84, 86 are positioned proximate top wall 72 of adapter 50. As used herein, forward and rearward directions define the position of structures of guide assembly 10 relative to a tow vehicle 16. That is, forward structures are generally nearer to tow vehicle 16 than corresponding rearward structures when guide assembly 10 is engaged therewith. Similarly, right side and left side designations describe positions with respect to a vehicle orientation wherein the driver-side is a left-side and a passenger side is a right side. Furthermore, as used herein, those structures being defined as being outboard relative to other structures, are understood to be further from a central portion of the structure as compared to the other recited structures.

Forward openings 84 and rearward openings 86 of each sidewall 74, 76 are generally aligned to support a forward shaft 90 and a rearward shaft 92, respectively. Each end 94, 96, 98, 100 of each shaft 90, 92 includes a land 102 and a shoulder 104 that is positioned inboard relative to the nearest adjacent land 102. Referring to FIGS. 3 and 7, a roller cam or cam 106, 108, 110, 112 is supported by a respective land 102. A fastener 114 and a washer 116 cooperates with each end 94, 96, 98, 100 of each shaft 90, 92 to secure each respective cam 106, 108, 110, 112 thereto. When engaged with adapter 50, left-side forward and rearward cams 106, 110 are held in relatively close proximity to sidewall 74 of adapter 50. Similarly, left-side forward cam 108 and left-side rearward cam 112 are also held in close proximity to an outboard side of side wall 76 of adapter 50.

Referring back to FIG. 3, a forward facing open cavity 120 is formed in guide 20 and is sized to slidably cooperate with adapter 50. Guide 20 includes a rearward facing wall 122 that extends between sidewalls 24, 26. Each sidewall 24, 26 of guide 20 includes a first or forward cam path or channel 124 and a second or rearward cam path or channel 126. Each forward channel 124 includes a first portion or section 128 and a second portion or section 130. Preferably, sections 128, 130 are oriented in crossing directions. More preferably, sections 128, 130 of each forward channel 124 intersect one another at an obtuse angle, indicated by arrow 132. Each forward channel 124 operatively cooperates with a respective forward cam 106, 108.

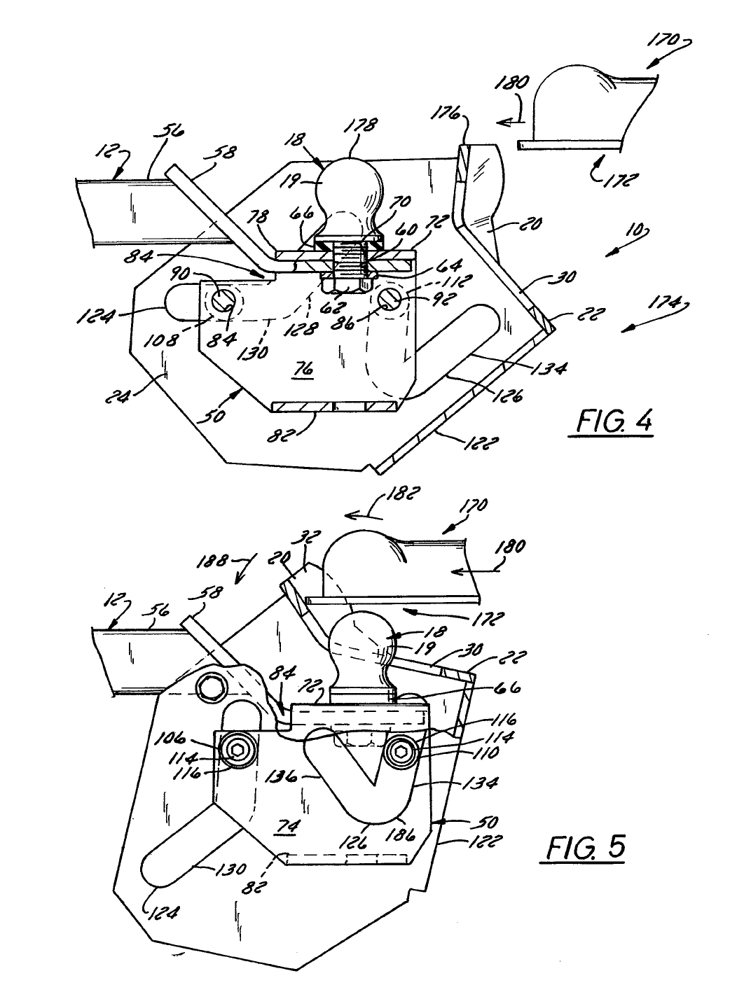

Each rearward channel 126 also includes a first portion or section 134 and a second portion or section 136. First and second channel sections 134, 136 are also oriented in crossing directions. Preferably, each first and second channel section 134, 136 of each respective rearward channel 126 are oriented so as to intersect one another at an acute angle, indicated by arrow 138. Each rearward channel 126 operatively cooperates with a respective rearward cam 110, 112. As described further below with respect to FIGS. 4-7, cams 106, 108, 110, 112 cooperate with a respective channel 124, 126 formed in a respective sidewall 24, 26 of guide 20 such that top plate 22 of guide 20 is movable in vertical as well as longitudinal directions relative to ball assembly 18. As used herein, longitudinal is generally indicative of directions aligned with a direction of travel of the vehicle and towable device.

It is appreciated that cams 106, 108, 110, 112 and channels 124, 126 of each sidewall 24, 26 provide a cam interface between guide 20 and adapter 50. It is further appreciated that the cam interface generally defined by the interaction of each cam 106, 108, 110, 112 and respective forward and rearward channel 124, 126 could be provided in a variety of alternative configurations. This is, comparable channels 124, 126 could be formed in adapter 50 and cams 106, 108, 110, 112 could be supported by guide 20 without substantially altering or interfering with the movement of guide 20 relative to ball assembly 18. Such alternatives are envisioned and within the scope of the appended claims.

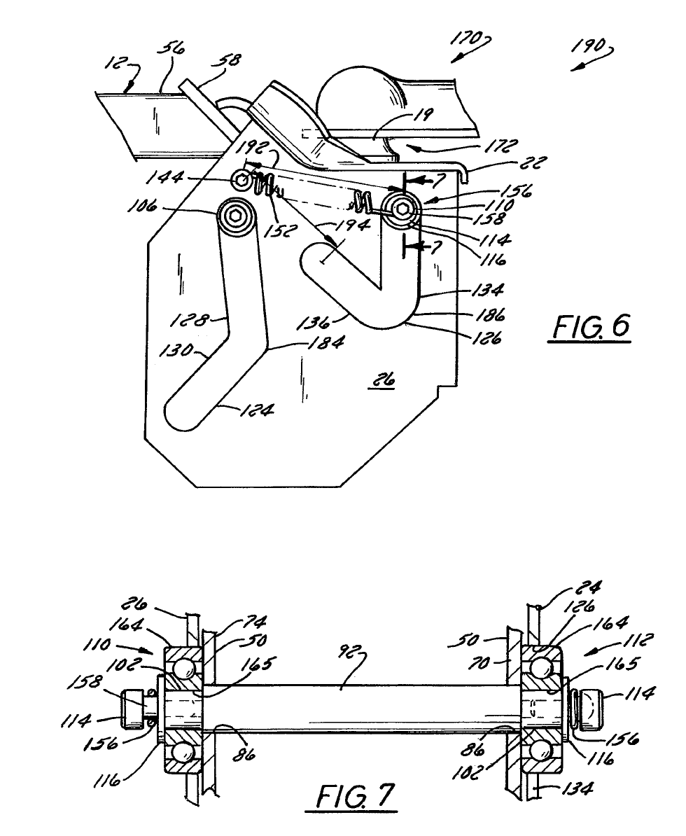

Still referring to FIG. 3, a support post 144 is secured to each of sidewalls 24, 26 of guide 20. Each support post 144 includes a shank portion 146 and a threaded portion 148 that is formed at a sidewall facing end 149 thereof. A threaded cavity 150 is formed in each of sidewalls 24, 26 and operatively receives threaded portion 148 of a respective support post 144. A biasing device 152, such as a spring, includes a first end 154 that is secured to support post 144 associated with each respective side wall 24, 26 and a second end 156 that cooperates with a shank portion 158 of the fastener 114 that secures each of rear cams 110, 112 to rear shaft 92. As described further below with respect to FIG. 6, biasing devices 152 bias guide 20 to an “up” position wherein the guide assembly 10 is positioned for guided interaction with a tongue of a towable device and toward a “down” position wherein a towable device 170 has been engaged therewith.

Each sidewall 24, 26 of guide 20 includes a number of threaded cavities 157, 159, 160 that are positioned to cooperate with respective fasteners 36, 38, 40 associated with each cover 34. Each of fasteners 36, 38, 40 can be constructed to cooperate with optional spacers 46 to maintain gap or offset 48 (FIG. 2) between each respective cover 34 and inboard positioned sidewalls 24, 26 of guide 20 to provide unobstructed operation of biasing device 152. Alternatively, fasteners 114, and/or support post 144 can be configured to provide the desired spacing between each respective cover 34 and the movable parts associated with operation of guide assembly 10.

Referring to FIGS. 3 and 7, to attach guide assembly 10 to drop 12, adapter 50 is first secured to flat section 58 of drop 12 via the cooperation of ball assembly 18 with opening 70 formed an adapter 50. Guide 20 is then translated over the drop 12 and adapter 50 assembly such that channels 124, 126 of guide 20 generally overlie respective openings 84, 86 formed in adapter 50. Shafts 90, 92 are then engaged with openings 84, 86 such that lands 102 generally extend through a respective channel 124, 126 of the respective sidewall 24, 26 of guide 20. Cams 106, 108, 110, 112 are then engaged with a respective land 102 of shaft 90, 92 such that, as best shown in FIG. 7, an outer surface 164 of each cam 106, 108, 110, 112 operatively cooperates with a respective channel 124, 126 of the respective sidewall 24, 26 of guide 20 whereas an inner surface 165 of each cam 106, 108, 110, 112 engages a respective land 102 of each end 94, 96, 98, 100 of each respective shaft 90, 92. The cooperation of each of respective cams 106, 108, 110, 112 of guide assembly 10 with respective channels 124, 126 of guide 20 generally secures guide 20 to drop 12 via adapter 50 such that guide 20 is movable relative to drop 12 and ball 19 of ball assembly 18.

FIGS. 4-6 show the movement of guide 20 relative to ball assembly 18 during engagement and disengagement of a towable device 170 from ball assembly 18. Although towable device 170 is shown as what is commonly understood to be the tongue or trailer tongue of such vehicles, it is appreciated that towable device 170 could be any of a trailer or device configured to haul other materials, supplies, devices, or equipment, or could be a towable non-self moving device, such as wood splitters, chippers, pullable finish mowers, cement or mortar mixers, etc. Regardless of its use or specific configuration, towable device 170 commonly includes a pocket 172 that snuggly engages ball 19 and a latch (not shown) that otherwise secures ball 19 within pocket 172. It is further appreciated that ball 19 and pocket 172 are provided in a number of common sizes such as 1⅝ inches, 1⅞ inches, 2 inches, etc.

As shown in FIG. 4, when oriented in an “up” position 174, top plate 22 of guide 20 is maintained at a generally inclined orientation that is generally rearward of ball 19. When oriented in up position 174, a forward top edge 176 of top plate 22 is positioned generally above a top surface 178 of ball 19. Such an orientation prevents towable device 170 from directly contacting ball 19 when guide 20 is oriented in up position 174. Still referring to FIG. 4, each forward cam 106, 108 and each rearward cam 110, 112 are positioned in the forward portions 130, 136 of each respective channel 124, 126 of guide 20 when guide 20 is in up position 174.

As shown in FIG. 5, as the towing vehicle and towable device 170 are introduced to one another, indicated by arrow 180, guide 20 rotates in an upward and forward direction, indicated by arrow 182, as each forward and rearward channel 124, 126 translates along each respective cam 106, 108, 110, 112. As each cam 106, 108, 110, 112 passes an apex 184, 186 formed by the intersection of each respective section 128, 130 and 134, 136 of each respective forward and rearward channel 124, 126, upward and forward direction 182 of guide 20 changes to a downward and forward direction 188 as each forward cam 108, 110 enters first section 128 of each forward channel 124 and each rearward cam 110, 112 enters first section 134 of each rearward channel 126.

Referring to FIG. 6, when towable device 170 achieves a forward position wherein ball 19 can pass into pocket 172, guide 20 achieves a “down” position 190 wherein ball 19 passes fully through opening 30 such that top plate 22 of guide 20 generally overlies adapter 50 in a generally parallel manner. As shown in FIG. 6, a length 192 of biasing device 152 when guide 20 is in down position 190 is slightly greater than a length 194 of biasing device 152 when guide 20 is in up position 174. As such, biasing device 152 is configured to bias guide 20 toward up position 174.

During a process of engaging towable device 170 with ball assembly 18, as guide 20 is translated in a forward and upward direction due to the interaction between the towing vehicle and the towable device 170, guide 20 translates such that apexes 184, 186 of respective channels 124, 126 approach respective cams 108, 112 thereby increasing the load of biasing device 152. The downward pressure associated with the interaction of towable device 170 with guide 20 translates guide 20 in a downward direction along sections 128, 134 of each respective channel 124, 126 such that ball 19 can pass uninterruptedly into pocket 172. Operator manipulation of the latch of towable device 170 secures towable device 170 to drop 12 via ball 19.

When it is desired to remove towable device 170 from ball 19, guide 20 translates in an upward direction so that each of channels 124, 126 translates in an upward direction as first portions 128, 134 translates over cams 106, 108, 110, 112 until cams 106, 108, 110, 112 reach apexes 184, 186, respectively. Upon cams 106, 108, 110, 112 reaching apexes 184, 186, biasing device 152 translates guide 20 in rearward and downward direction as each of cams 106, 108, 110, 112 translates along each respective second section 130, 136 of each respective channel 124, 126. Such motion translates towable device 170 in a generally rearward direction relative to ball 19 with the force associated with biasing device 152 translating guide 20 relative to cams 106, 108, 110, 112. Regardless of the direction of guide 20 in either the up or down directions, the load of biasing device 152 is greatest when cams 106, 108, 110, 112 are positioned at the apex 184, 186 associated with the respective channel 124, 126. Preferably, each lateral side of guide 20 is provided with a biasing device 52 as indicated by the ends thereof as shown in FIG. 7. Understandably, other biasing devices or biasing devices more resistive to displacement may be provided such that only one such biasing device is used.

Referring again to FIG. 6, when guide 20 is orientated in down position 190, ball 19 extends beyond top plate 22 of guide 20 such that the load of towable device 170 is communicated directly to ball 19. From ball 19, the load associated with towable device 170 is communicated directly to drop 12. When secured to a towing vehicle, guide assembly 10 does not interfere with the communication of the load of towable device 170 directly to the vehicle via the interaction of the drop 12 and the receiver 14. Accordingly, in addition to assisting with lateral and vertical alignment of towable device 170 with ball 19 during both connection and disengagement operations, hitch guide assembly 10 does not interfere with the generally direct connection of the load of the towable device to the towing vehicle via the conventional drop and ball assembly.

Hitch guide assembly 10 can be easily integrated with already owned hitch drop and ball assemblies, provides a towable device connection guide assembly that is easily operable, and provides a guide assembly that assists with lateral and vertical alignment of a towable device with a towing vehicle. Furthermore, in providing a guide assembly that is not required to withstand the rigors of towing operations, guide assembly 10 provides a hitch guide that is robust yet economical. Accordingly, guide assembly 10 has a number of advantages over other known hitch guide assemblies.

Therefore, one embodiment of the invention includes a hitch guide assembly for assisting in connecting towable devices to a tow vehicle. The hitch guide assembly includes a body for being secured to the tow vehicle in a fixed position. A post or ball extends from the body for engaging a tongue of the towable device. A guide is movably secured to the body so as to be movable with respect to the post. A first cam and a second cam are positioned on generally opposite lateral sides of the body. Each of the first and second cams cooperates with a forward channel formed in a respective side of the guide. A third cam and a fourth cam are positioned rearward of the first and second cams and positioned on the opposite lateral sides of the body. Each of the third and fourth cams cooperates with a rearward channel formed in the respective sides of the guide.

Another embodiment of the invention usable with one or more of the aspects or embodiments above includes a hitch assembly having a tube for being received in a receiver securable to a tow vehicle. The assembly includes a ball for engaging the tube and for cooperating with a tongue of a towable device and an adapter for being secured to the tube. A forward cam shaft and a rearward cam shaft are secured to the adapter. A cam is secured to each generally lateral opposite end of each cam shaft. The assembly includes a guide that has a top wall and a pair of opposite lateral side walls. An opening is formed in the top wall and shaped to allow the ball to pass uninterrupted therethrough. A forward cam path and a rearward cam path are formed in each side wall. Each cam path cooperates with a respective cam to define motion of the guide relative to the ball. A biasing device biases the guide to a position wherein the opening is generally above the ball.

A further embodiment of the invention usable with one or more of the aspects and embodiments disclosed above includes a method of selectively exposing a ball for engaging a trailer. The method includes the steps of mounting an adapter to a hitch having a ball secured thereto. A guide is secured to the adapter with a number of cam interfaces such that the guide is movable between a raised position wherein a top wall of the guide is positioned over the ball and a lowered position wherein the top wall is positioned generally below the ball. The method includes biasing the guide toward the raised position. The present invention has been described in terms of the preferred embodiment, and it is recognized that equivalents, alternatives, and modifications, aside from those expressly stated, are possible and within the scope of the appending claims.

What is claimed is:

1. A hitch guide assembly for assisting in connecting towable devices to a tow vehicle, the hitch guide assembly comprising:
a body for being secured to the tow vehicle in a fixed position such that a post extends from the body for engaging a tongue of the towable device;
a guide movably secured to the body a first cam and a second cam that are positioned on opposite lateral sides of the body, each of the first and second cams cooperating with a forward channel formed in a respective side of the guide; and
a third cam and a fourth cam positioned rearward of the first and second cams and positioned on opposite lateral sides of the body, each of the third and fourth cams cooperating with a rearward channel formed in the respective sides of the guide.

2. The hitch guide assembly of claim 1 wherein the first, second, third, and fourth cams cooperate with their respective channels so that a top portion of the guide can move in an upward and rearward direction relative to the post.

3. The hitch guide assembly of claim 1 wherein the post is further defined as a ball and the body includes an opening for removably cooperating with the ball.

4. The hitch guide assembly of claim 3 further comprising a number of different sized balls that interchangeably cooperate with the opening.

5. The hitch guide assembly of claim 1 further comprising a spring that biases that the guide to a position wherein the post is accessible at a location generally above a top plate of the guide.

6. The hitch guide assembly of claim 5 wherein the spring includes a first end that is secured proximate an axis of rotation of one of the third and fourth cams and a second end of the spring is secured to the guide at a location forward one of the first and second cams.

7. The hitch assembly of claim 5 further comprising another spring that is oriented similar to the first spring on a side of the guide that is laterally opposite the first spring.

8. The hitch assembly of claim 1 wherein the forward channel includes a first portion and a second portion that is oriented in a crossing direction relative to the first portion.

9. The hitch assembly of claim 8 wherein the rearward channel includes a first portion and a second portion that extends in a crossing direction relative to the first portion.

10. A hitch assembly comprising:
a tube for being received in a receiver securable to a tow vehicle;
a ball for engaging the tube and cooperating with a tongue of a towable device;
an adapter for being secured to the tube;
a forward cam shaft and a rearward cam shaft secured to the adapter;
a cam secured to each generally lateral opposite end of each cam shaft;
a guide having a top wall and a pair of opposite lateral side walls;
an opening formed in the top wall and shaped to allow the ball to pass uninterrupted therethrough;
a forward cam path and a rearward cam path formed in each of side wall, each cam path cooperating with a respective cam to define motion of the guide relative to the ball; and
a biasing device to bias the guide to a position wherein the opening is generally above the ball.

11. The hitch assembly of claim 10 wherein the biasing device is a spring having a first end secured to the guide and a second end secured proximate a cam that cooperates with one of the rearward cam paths.

12. The hitch assembly of claim 10 further comprising another biasing device positioned on an opposite lateral side of the hitch assembly relative to the biasing device.

13. The hitch assembly of claim 10 wherein the top wall of the guide is pitched toward the opening.

14. The hitch assembly of claim 10 wherein each forward cam path includes a first portion and a second portion that are oriented at an obtuse angle relative to one another.

15. The hitch assembly of claim 10 wherein each rearward cam path includes a first portion and a second portion that are oriented at an acute angle relative to one another.

16. The hitch assembly of claim 10 further comprising a cover positioned outboard of each side wall of the guide.

17. A method of selectively exposing a ball for engaging a trailer comprising the steps of:
mounting an adapter to a hitch having a ball secured thereto;
securing a guide to the adapter with a number of cam interfaces such that the guide is movable between a raised position wherein a top wall of the guide is positioned over the ball and a lowered position wherein the top wall is positioned generally below the ball; and
biasing the guide to the raised position.

18. The method of claim 17 wherein the guide is biased to the raised position by a force comparable to a tongue weight of the trailer.

19. The method of claim 17 further comprising forming the number of cam interfaces as a pair of cam interfaces on opposite lateral sides of the adapter and guide and forming each of the pair of cam interfaces as a first cam path that is different than a second cam path.

20. The method of claim 19 further comprising forming each of the pair of cam interfaces as mirror images of one another.
